(19) United States
(12) Patent Application Publication
(10) Pub. No.: US 2026/0245177 A1
(43) Pub. Date: Aug. 20, 2026

(54) METHOD OF THERMAL IMAGE PROCESSING, STORAGE MEDIUM, AND ELECTRONIC DEVICE THEREOF

(71) Applicant: TRIPLE WIN TECHNOLOGY(SHENZHEN) CO.LTD., Shenzhen (CN)

(72) Inventors: SHENG-PO TSENG, New Taipei (TW); Cheng-Chang Hsieh, New Taipei (TW); Shu-Ying Chen, New Taipei (TW); Cheng-Yuan Shih, New Taipei (TW)

(21) Appl. No.: 19/405,619

(22) Filed: Dec. 2, 2025

(30) Foreign Application Priority Data
Feb. 17, 2025 (CN) 202510172123.1

(51) Int. Cl. G06T 5/50; G06T 5/10; G06T 5/20

(52) U.S. Cl. CPC G06T 5/50; G06T 5/10; G06T 5/20; G06T 2207/10028; G06T 2207/10048; G06T 2207/20056; G06T 2207/20221

(57) ABSTRACT

A method of thermal image processing includes obtaining an original thermal image and a plurality of phase images related to a target scene by performing an image acquisition using a thermal image module and a time-of-flight ranging module respectively. A reference image is generated by overlapping the plurality of phase images, and a depth image is generated based on the plurality of phase images. A target thermal image is generated based on the original thermal image, the reference image, and the depth image. A first frequency domain image is generated based on the target thermal image. A second frequency domain image is generated based on the reference image. A fused thermal image is generated based on the first frequency domain image and the second frequency domain image. A non-transitory storage medium and an electronic device are also provided.

### TECHNICAL FIELD

The present application generally relates to image processing technology, and particularly to a method of thermal image processing, a storage medium, and an electronic device thereof.

### BACKGROUND

Thermal image cameras detect energy distributions of long-wavelength infrared radiation (LWIR) of infrared radiation emitted by an object located in a detection environment, thus a thermal image is formed. However, a temperature error between a detected temperature and an actual temperature of the formed thermal image in the related art is larger.

There is room for improvement in the art.

### BRIEF DESCRIPTION OF THE DRAWINGS

Implementations of the present application will now be described, by way of example only, with reference to the attached figures.

FIG. 1 is a diagram illustrating an embodiment of an electronic device according to the present application, the electronic device includes a camera module.

FIG. 2 is a diagram illustrating an embodiment of the cameral module of FIG. 1 according to the present application.

FIG. 3 is a flowchart illustrating an embodiment of a method of thermal processing according to the present application.

FIG. 4 is a diagram illustrating an embodiment of different types of images in different steps of the method of FIG. 3 according to the present application.

FIG. 5 a diagram illustrating an embodiment of formed images in different steps of the method of FIG. 3 according to the present application.

FIG. 6 is a diagram illustrating an embodiment of a computer readable storage medium according to the present application.

### DETAILED DESCRIPTION

The following clearly describes the technical solution in embodiments of this application with reference to the accompanying drawings in the embodiments of the application.

It should be noted that, when a component is considered to be “connected” to another component, it can be directly connected to the another component or an intermediate element may exist therebetween. When a component is considered as to be “fixed” to another component, it can be directly on the another component or an intermediate element may exist therebetween. The terms used in the present application, such as “top”, “bottom”, “up”, “down”, “left”, “right”, “front”, “rear” and similar expressions used herein are for illustrative purposes only, and do not represent unique embodiments.

Unless otherwise defined, meanings of all technical and scientific terms used in the present application are the same as the those generally understood by persons skilled in the art of the present application. The terms used in the specification of the present application herein are used only to describe specific embodiments, and not intended to limit the preset application.

In the description of the present disclosure, unless other specified, “/” means “or”. For example, A/B may indicate A or B. In this application, “and/or” describes only an association relationship for describing associated objects and indicates that three relationship may exist. For example, A and/or B may indicate the following three cases: Only A exists, both A and B exist, and only B exists.

In the description of the present disclosure, the words such as “first”, “second”, and the like, are used to distinguish different objects, and do not limit quantities and execution sequences. In addition, the words such as “first”, “second”, do not necessarily limit a definite difference. In addition, terms “include” and “have”, and any variant thereof are intended to cover the non-exclusive inclusion.

Thermal image cameras detect energy distributions of long-wavelength infrared radiation (LWIR) of infrared radiation emitted by an object located in a detection environment, thus a thermal image is formed. However, a temperature error between a detected temperature and an actual temperature of the formed thermal image in the related art is larger

Therefore, the present application provides a method of thermal image processing, a non-transitory computer readable storage medium, and an electronic device thereof, which improves the accuracy of the detected temperature of a target object reflected by the thermal image.

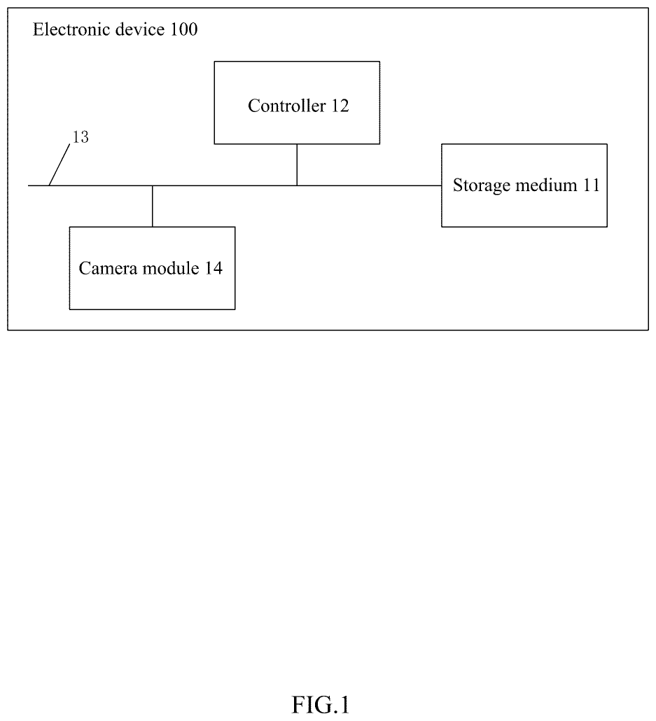

Referring to FIG. 1, FIG. 1 shows a diagram illustrating an electronic device 100 according to the present application. The method of thermal image processing of the present application is applied in an electronic device 100. Specifically, the method is executed by at least one controller 12 in the electronic device 100. The electronic device 100 includes a storage medium 11, the at least one controller 12, and a camera module 14, but not being limited. The storage medium 11, the at least one controller 12, and the camera module 14 communicate with each other through a communication bus 13. The cameral module 14 may be a camera device disposed on the electronic device 100, such as a thermal image module 141 and a time-of-flight ranging module 142.

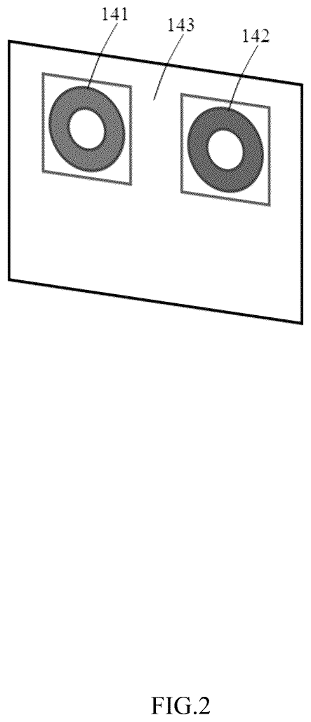

Referring to FIG. 2, FIG. 2 shows a diagram illustrating the camera module 14 according to the present application. The thermal image module 141 and the time-of-flight ranging module 142 are disposed on a same substrate 143, thus the related position between the thermal image module 141 and the time-of-flight ranging module 142 are constant.

It is understood that, FIG. 1 only shows an example of the electronic device 100, but not being limited. The electronic device 100 may include more or less components than those shown in FIG. 1, or some components may be combined, or a different component deployment may be used. For example, the electronic device 100 may further include an input/output device, a network access device, and a display, and so on.

In one embodiment, the electronic device 100 may be a wearable device, such as a smart helmet, a smart glass, and so on. The detail form of the electronic device 100 is not limited in the present application.

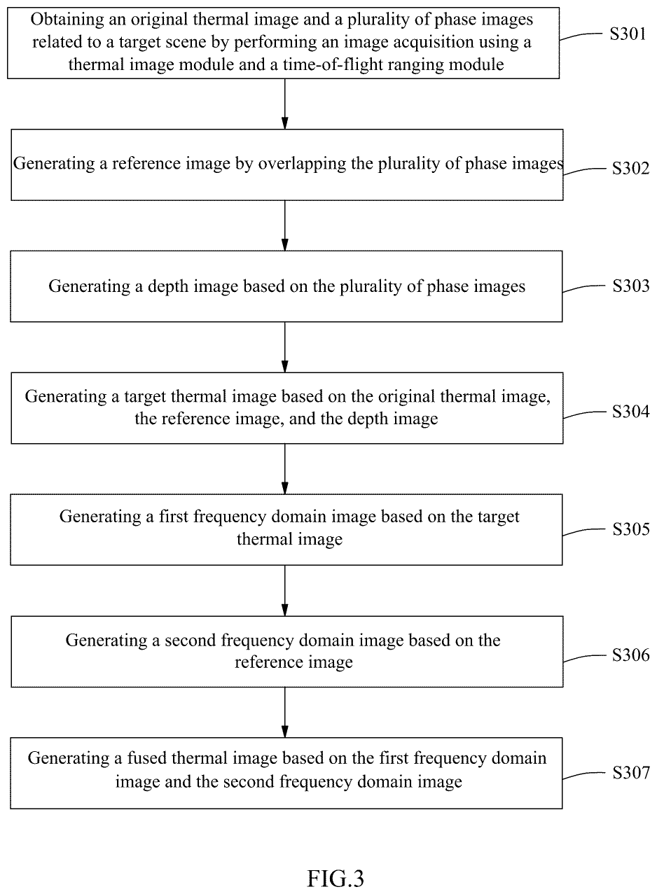

Referring to FIG. 3, FIG. 3 shows a flowchart of the method of thermal image processing according to the present application. Due to different requirements, steps described as sequential may be modified, combined, added or omitted. It is understood that, the steps shown in FIG. 3 may be extended by the at least one controller 12 (as shown in FIG. 1). Referring to FIG. 3, the method of thermal image processing includes:

In block S301, an original thermal image and a plurality of phase images related to a target scene are obtained by performing an image acquisition using the thermal image module 141 and the time-of-flight ranging module 142 respectively.

The thermal image module 141 is configured to detect infrared energy radiated by a detected object, and generate the original image based on the infrared energy radiated by the detected object. The time-of-flight ranging module 142 is configured to emit laser pulse, such as infrared light, and measure a time difference between the emitted laser pulse and the reflected laser pulse. The distance is calculated by the time-of-flight ranging module 142 based on the time difference. In detail, receiving terminals of the time-of-flight ranging module 142 are configured to sample the energy values of the received signals in different phase values (such as 0°, 90°, 180°, 270°). The energy values are configured to calculate a phase difference for analyzing the distance between the cameral module 14 and the detected object. The phase difference is proportional to the distance. A depth value related to each pixel point may be calculated by the phase difference. For improving the accuracy and robustness of a detecting result, the time-of-flight ranging module 142 repeats the above process on different time points for generating the plurality of phase images. It is understood that, phase values of all of the pixel points form a two-dimensional image as the phase image. Each phase value of the pixel points represents distance information between the pixel point to the camera module 14.

In some embodiments, before the block S301, intrinsic parameters and extrinsic parameters corrections may be executed to the thermal image module 141 and the time-of-flight ranging module 142 using a calibration pattern board. Thus, the original thermal image and the phase images related to the target scene are aligned, which are acquired by performing the image acquisition using the thermal image module 141 and the time-of-flight ranging module 142.

In some embodiments, while receiving synchronization signals, the block S301 executes. Therefore, the images acquired by the thermal image module 141 and the time-of-flight ranging module 142 maintain being synchronized with each other. The synchronization signals may be triggered by users or be outputted by the controller 12. The source of the synchronization signals of the present application is not being limited.

In block S302, a reference image is generated by overlapping the plurality of phase images.

In some embodiments, the plurality of phase images related to a common pixel point are performed an averaging process or a weighting process, for overlapping the phase image to obtain the reference image. The detail algorithm applied in the block S302 of the present application is not being limited.

In block S303, a depth image is generated based on the plurality of phase images.

In some embodiments, a distance corresponding to each pixel point is calculated by the plurality of phase image, and a gray value corresponding to each pixel point is converted by the distance corresponding to each pixel point for generating the depth image. For example, the grave value in the depth image is proportional to the distance. Therefore, the farther distance between each pixel point and the time-of-flight range module 142 is, the greater the gray value in the depth image. Oppositely, the closer distance between each pixel point and the time-of-flight range module 142 is, the less the gray value in the depth image.

In block S304, a target image is generated based on the original thermal image, the reference image, and the depth image.

It is understood that, the thermal image module 141 usually presets a default emissivity, and corrects the obtained temperature using a Black body. However, the target scene may include objects with emissivity different from the default emissivity. Therefore, a temperature error between the converted temperature and an actual temperature of the object with emissivity different from the default emissivity in the target scene is existed. In block S304, the reference image is used to identify a class of the object with the emissivity different from the default emissivity, and the emissivity of the object with the emissivity different from the default emissivity is confirmed based on the identified class, for correcting the temperature of the object with the emissivity different from the default emissivity.

Further, while the LWIR generated by the infrared radiation broadcasts in the air, the strengths of the infrared radiation will decrease as the broadcasted distance is farther. Thus, while measuring the temperature by the thermal image module 141, a measure error will increase as the broadcasted distance is farther. In the block S304, the temperature of the original thermal image is corrected based on the distance calculated by the depth image.

Therefore, in the block S304, the obtained temperature of the target thermal image is more accuracy based on the original thermal image, the reference image, and the depth image.

In some embodiment, the block S304 further includes the following steps.

In block S401, a correction thermal image is generated by using the depth image to correct the original thermal image.

It is understood that, the gray value of each pixel point in the depth image presents the distance between each pixel point and the time-of-flight ranging module 142. Thus, in block S401, the distance of each pixel point is obtained by acquiring the gray value of each pixel point.

In some embodiments, the block S401 further includes the following steps.

In block S4011, the gray value of each pixel point in the depth image is acquired.

In block S4012, the temperature corresponding to each pixel point is corrected by using the acquired gray value, to obtain the correction thermal image.

In some embodiments, a look-up operation may be executed for acquiring a temperature compensation value corresponding to the acquired gray value, thus the correction temperature of each pixel point is calculated using the temperature compensation value and the temperature of the original thermal image, the correction temperature replaces the temperature of the corresponding original thermal image in the thermal image, to obtain the correction thermal image. In that means, the temperature of each pixel point in the correction thermal image is corrected by the depth image.

In some embodiments, a look-up table between the gray value and the temperature compensation value is preset, and is stored in the storage medium 11. In other embodiments, there are a plurality of look-up tables stored in the storage medium 11 based on different factors, such as air humidity, air density. Therefore, the correction of the temperature of the correction thermal image in the block S401 is more finely.

In block S402, the objects in the target scene and each class of the objects are confirmed based on the reference image.

In some embodiments, the reference image is processed by YOLO algorithm, DETR algorithm, or neural network, to obtain the objects in the target scene and each class of the objects. The detailed algorithm in the block S402 of the present application is not being limited.

In block S403, the emissivity corresponding to each class of the objects is confirmed. In some embodiments, by executing a lookup operation, the emissivity corresponding

to each class of the objects is obtained. Similarly, a look-up table between the class and the emissivity is preset and is stored in the storage medium 11. Therefore, by executing the block S403, the emissivity corresponding to each class of the objects is confirmed.

In block S404, the target thermal image is generated based on the correction thermal image and the emissivity corresponding to each class of the objects.

In the block S404, the original thermal image is aligned with the phase images. Correspondingly, the correction thermal image by processing the original thermal image is also aligned with the reference image generated by the phase images. Therefore, the identified object in the block S403 also exists in the correction thermal image. Thus, the temperature error in the correction thermal image is further reduced based on the emissivity corresponding to the class of the identified object.

In some embodiments, the block S404 further includes the following steps.

In block S4041, a pixel region corresponding to each object in the correction thermal image is obtained.

In some embodiments, the region of interest corresponding to each object generated in the step of block S403 is directly obtained, and the pixel region corresponding to each object in the correction thermal image is obtained based on each region of interest.

In block S4042, a temperature corresponding to each pixel region is corrected based on the pixel region and the corresponding emissivity, to obtain the target thermal image.

In some embodiments, the temperature corresponding to the each pixel region is calculated by the following formula.

$$T c = T m \times [ {( 1 / ∈ O )}^{1 / 4} ]$$

Wherein, Tc represents the corrected temperature corresponding to each pixel region; Tm represents the temperature corresponding to each pixel region in the thermal image; E 0 represents the emissivity corresponding to each pixel region.

In some embodiments, the temperatures of all the pixel points in the pixel region are performed by an averaging process or a weighting process, to obtain the temperature of the corresponding pixel region.

Further, the corrected thermal image is updated based on the temperature of the pixel region, which is calculated based on the corresponding emissivity.

Based on the above recited, by executing the block S401 to the block S404, the target thermal image is generated, for implementing the block S304.

In block S305, a first frequency domain image is generated based on the target thermal image.

In some embodiments, the target thermal image performs an approximate Fourier transform to obtain the first frequency domain image.

In block S306, a second frequency domain image is generated based on the reference image.

In some embodiments, the reference image performs an approximate Fourier transform to obtain the second frequency domain image.

In other embodiments, for enriching details of the image, the block S305 may include the following steps.

In block S601, an image enhancing process is performed on the target reference image to generate a target reference image.

In some embodiments, the target reference image may be executed a filter process, and an edge detection process, and so on, thus the target reference image is generated. The detail algorithm applied in the block S601 of the present application is not being limited.

In block S602, a Fourier transform and a high pass filter are performed on the target reference image to generate the second frequency domain image.

Therefore, by executing the block S601 and the block S602, the second frequency domain image is generated based on the reference image.

In block S307, a fused thermal image is generated based on the first frequency domain image and the second frequency domain image.

In some embodiments, the block S307 may include the following steps.

In block S701, a third frequency domain image is generated by overlapping the first frequency domain image and the second frequency domain image.

In some embodiments, the first frequency domain image and the second frequency domain image are performed an averaging process, different weight are given to the spectral components of the first and second frequency domain images, and an overlapping operation is executed. In other embodiments, both of the first and second frequency domain images are decomposed into sub-images with different frequency bands, and the sub-images are fused in each frequency band. For example, the sub-images in a lower frequency band correspond to a greater weight, and the sub-images in a higher frequency band correspond to a less weight. The detail applied in the block S701 of the present application is not being limited.

In block S702, an inverse Fourier transform is performed on the third frequency image to generate the fused thermal image.

As the above description, the method of thermal image processing of the present application obtains the original thermal image and the plurality of phase images by the thermal image module 141 and the time-of-flight ranging module 142, generates the reference image by correcting the temperature of the original thermal image using the class and emissivity of each object identified from the reference image and distance information in the depth image, generates a fused thermal image by fusing the first and second frequency domain images, which are generated based on the target thermal image and the reference thermal image. Thus, the accuracy of the temperature data in the fused thermal image is improved, and the fused thermal image has a rich detail. The method of thermal image processing of the present application may effectively improve the measurement precision of the thermal image.

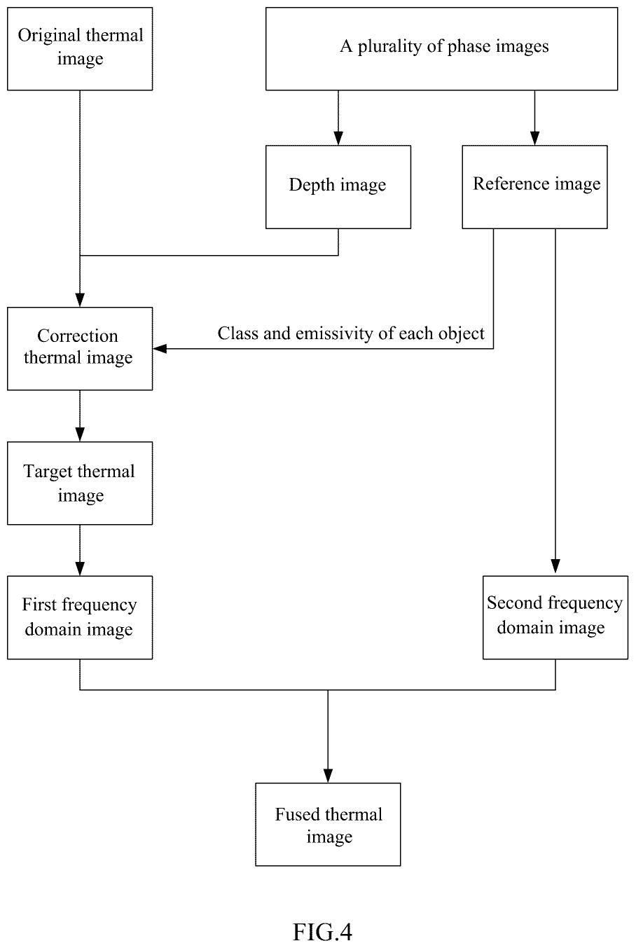

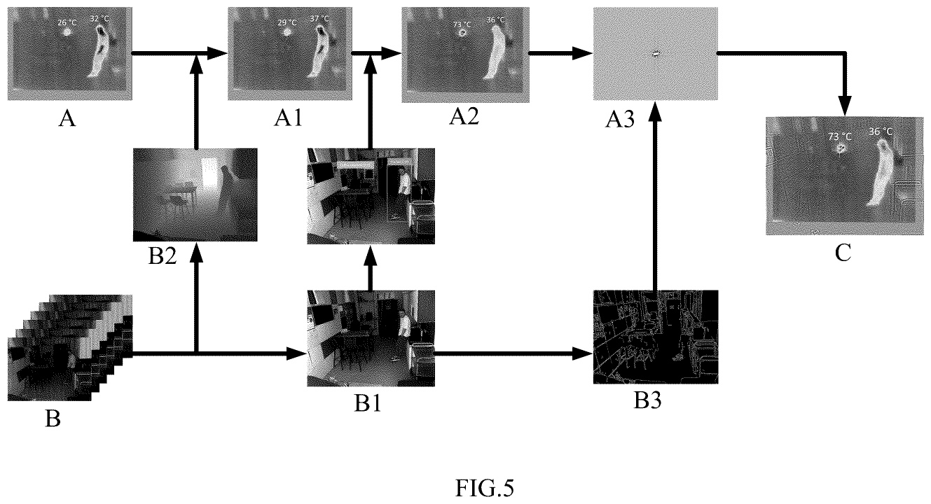

Referring to FIGS. 4 and 5, FIG. 4 shows different types of images in different steps of the method of FIG. 3 of the present application, and FIG. 5 shows formed images in different steps of the method of FIG. 3 of the present application. It is understood that, the thermal camera module 141 outputs the original thermal image A, the time-of-flight ranging module 142 outputs the plurality of phase images B. The reference image B1 is overlapped by the plurality of the phase images B, and the depth image B2 is generated based on the plurality of phase images B. Then, the correction thermal image A1 is generated by using the depth image B2 to correct the original thermal image. The objects in the reference image B1 and class of each object in the reference image B1 are confirmed, such as a coffee machine and humanity. Further, the emissivity corresponding to each class is confirmed. The target thermal image A2 is generated based on the correction thermal image A1 and the emissivity corresponding to each class. The first frequency domain image A3 is generated by processing a Fourier transform, and the second frequency domain image B3 is generated by performing a Fourier transform and a high pass filtering on the reference image B1. Finally, the fused thermal image C is generated by fusing the first frequency domain image A3 and the second frequency domain image B3.

Thus, by the thermal image process, the temperature of a nozzle of the coffee machine in the original thermal image A changes from 26° into 73° in the fused thermal image C. The temperature of a human body in the original thermal image A changes from 32° into 36° in the fused thermal image C. Th accuracy of the temperature in the thermal image is greatly improved.

Referring to FIGS. 1 and 2, the present application also provides an electronic device 100. The electronic device 100 includes the thermal camera module 141, the time-of-flight ranging module 142, and at least one controller 12. The at least one controller 12 is configured to execute the method of thermal image processing as recited above in any embodiments.

It is understood that, the foregoing at least one controller 12 may be a central processing unit (CPU), and also may be other general purpose processor, a digital signal processor (DSP), an Application Specific Integrated Circuit (ASIC), a Field-Programmable Gate Array (FPGA) or other programmable logic devices, discrete gate or transistor logic devices, discrete hardware components, and so on. The general purpose processor may be a microprocessor or any conventional processor. The at least one controller 12 is a control center of the electronic device 100, and is connected to various parts of the entire electronic device 200 by using various interfaces and lines.

The storage medium 11 is configured to store the computer programs and/or modules. The at least one controller 12 runs or executes the computer programs stored in the storage medium 11 to implement various functions of the electronic device 100. The storge medium 11 may mainly include a program storage area and a data storage area. The program storage area may store an operating system and an application program required by at least one function (such as a sound playback function, an image playback function, and so on). The data storage area may store data created according to the use of the electronic device 100 and the like. In addition, the storage medium 11 may include a non-transitory storage medium, such as a hard disk, a memory, a plug-in hard disk, a smart memory card, a secure digital card, a Flash Card, at least one magnetic disk storage device, flash memory device, or other non-transitory solid-state storage device.

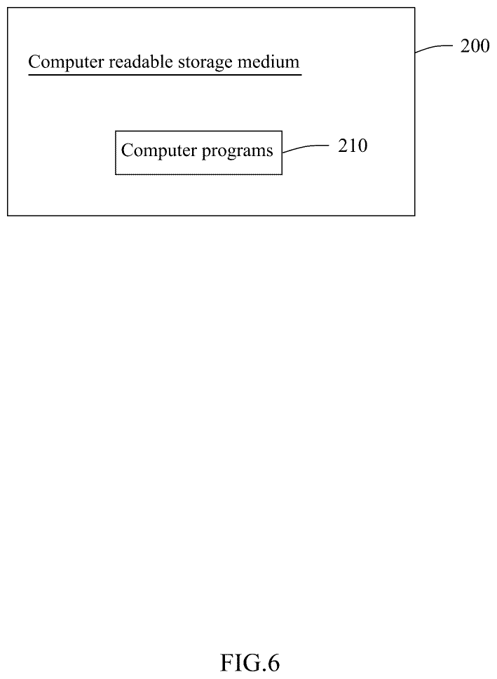

Referring to FIG. 6, the present application further provides a computer readable storage medium 200. The computer readable storage medium 200 stores computer programs 210. The computer programs 210 are suitable for the at least one controller 12 to execute and implement the method of thermal image processing of the foregoing embodiment. Therefore, details are not described herein again.

Exemplary, the computer program 210 may be divided into one or more modules/units, and the one or more modules/units are stored in the computer readable storage medium 200 and executed by the at least one controller 12 to complete this application. The one or more modules/units can be a series of computer program instruction segments capable for performing a specific function which used to describe the execution of computer program 210 in electronic device 200.

Based on such an understanding, in this application, all or some of the procedures of the methods in the foregoing embodiments may be implemented by a computer program instructing related hardware. The computer program may be stored in a computer-readable storage medium. When the computer program is executed by a processor, the steps in the foregoing method embodiments can be implemented. The computer program includes computer program code, and the computer program code may be in a source code form, an object code form, an executable file form, some intermediate forms, or the like. The computer readable medium may include at least any entity or apparatus, a recording medium, a computer memory, a read-only memory (ROM), a random access memory (RAM), an electrical carrier signal, a telecommunications signal, and a software distribution medium that can carry computer program code to a terminal device, for example, a USB flash drive, a mobile hard disk, a magnetic disk, or a compact disc. In some jurisdictions, according to legislation and patent practice, a computer readable medium cannot be an electrical carrier signal or a telecommunications signal.

In embodiments provided in this application, it should be understood that the disclosed electronic device and method may be implemented in other manners. For example, the described device embodiment is merely an example. For example, the module and division into the units is merely logical function division and may be other division in actual implementation.

In the several embodiments provided by the present disclosure, it should be understood that the disclosed computer devices and methods can be implemented in other ways. For example, the embodiment of the computer device described above is only schematic. For example, the division of the unit is only a logical function division, and there may be other division modes in actual implementation.

In addition, each functional unit in each embodiment of the disclosure can be integrated in the same processing unit, each unit can exist separately, or two or more units can be integrated in the same unit. The above integrated units can be performed in the form of hardware or hardware plus software function modules.

It will be obvious to those skilled in the art that the disclosure is not limited to the details of the above exemplary embodiments, and the disclosure can be performed in other specific forms without departing from the spirit or basic features of the disclosure. Thus, regardless of which viewpoint is taken, the embodiments should be regarded as being demonstrative and non-limiting; the scope of the present application is defined by the attached claims and not by the explanation above, hence it is intended that all changes falling within the meaning and scope of equivalent key elements of the claims be included in the present application. No reference signs in the claims should be regarded as limiting the claims concerned. In addition, it is clear that the word “including” does not exclude other units or steps, and the singular does not exclude the plural. The multiple units or computer devices stated in claims of the computer device may also be implemented by the same unit or computer device through software or hardware. Words such as “first”, “second” are used for naming, not any specific order.

It should be noted that the above accompanying drawings are only schematic descriptions of the processes included in the methods according to the exemplary embodiments of the present application, and are not intended to limit.

The present application is not limited to the above specific embodiments. Those skilled in the art will easily understand that there are many alternatives to the electronic device 100 of the present application without departing from the principles and scope of the present application. The scope of the present application is subject to the contents of the claims.

What is claimed is:

1. A method of thermal image processing, comprising:
obtaining an original thermal image and a plurality of phase images related to a target scene by performing an image acquisition using a thermal image module and a time-of-flight ranging module respectively;
generating a reference image by overlapping the plurality of phase images;
generating a depth image based on the plurality of phase images;
generating a target thermal image based on the original thermal image, the reference image, and the depth image;
generating a first frequency domain image based on the target thermal image;
generating a second frequency domain image based on the reference image; and
generating a fused thermal image based on the first frequency domain image and the second frequency domain image.

2. The method of claim 1, wherein generating the target thermal image based on the original thermal image, the reference image, and the depth image, comprising:
generating a correction thermal image by using the depth image to correct the original thermal image;
confirming at least one object in the target scene and a class of each of the at least one object based on the reference image;
confirming an emissivity corresponding to each class of the at least one object; and
generating the target thermal image based on the correction thermal image and the emissivity corresponding to each class of the at least one object.

3. The method of claim 2, wherein generating a correction thermal image by using the depth image to correct the original thermal image, comprising:
acquiring a gray value of each pixel point in the depth image; and
correcting a temperature of the pixel point in the original thermal image by the gray value, to obtain the correction thermal image.

4. The method of claim 2, wherein the emissivity corresponding to each class of the at least one object is obtained by a look-up operation in the storage medium.

5. The method of claim 2, wherein generating the target thermal image based on the correction thermal image and the emissivity corresponding to each class of the at least one object, comprising:
obtaining a pixel region corresponding to each object in the correction thermal image; and
correcting a temperature corresponding to each pixel region based on the pixel region and the corresponding emissivity, to obtain the target thermal image.

6. The method of claim 1, wherein generating the second frequency domain image based on the reference image, comprising:
performing an image enhancing process on the target reference image to generate a target reference image; and
performing a Fourier transform and a high pass filter on the target reference image, to generate the second frequency domain image.

7. The method of claim 1, wherein generating the fused thermal image based on the first frequency domain image and the second frequency domain image, comprising:
overlapping the first frequency domain image and the second frequency domain image, to generate a third frequency domain image; and
performing an inverse Fourier transform, to generate the fused thermal image.

8. The method of claim 1, wherein before obtaining the original thermal image and the plurality of phase images related to the target scene by performing the image acquisition using the thermal image module and the time-of-flight ranging module respectively, the method further comprising:
receiving synchronization signals for controlling the thermal image module and the time-of-flight ranging module to obtain the original thermal image and the plurality of phase images respectively.

9. A non-transitory storage medium having computer programs stored thereon, which when executed by at least one controller, a method of thermal image processing is implemented, wherein the method of thermal image processing comprises:
obtaining an original thermal image and a plurality of phase images related to a target scene by performing an image acquisition using a thermal image module and a time-of-flight ranging module respectively;
generating a reference image by overlapping the plurality of phase images;
generating a depth image based on the plurality of phase images;
generating a target thermal image based on the original thermal image, the reference image, and the depth image;
generating a first frequency domain image based on the target thermal image;
generating a second frequency domain image based on the reference image; and
generating a fused thermal image based on the first frequency domain image and the second frequency domain image.

10. The non-transitory storage medium of claim 9, wherein generating the target thermal image based on the original thermal image, the reference image, and the depth image, comprising:
generating a correction thermal image by using the depth image to correct the original thermal image;
confirming at least one object in the target scene and a class of each of the at least one object based on the reference image;
confirming an emissivity corresponding to each class of the at least one object; and
generating the target thermal image based on the correction thermal image and the emissivity corresponding to each class of the at least one object.

11. The non-transitory storage medium of claim 10, wherein generating a correction thermal image by using the depth image to correct the original thermal image, comprising:
acquiring a gray value of each pixel point in the depth image; and
correcting a temperature of the pixel point in the original thermal image by the gray value, to obtain the correction thermal image.

12. The non-transitory storage medium of claim 10, wherein generating the target thermal image based on the correction thermal image and the emissivity corresponding to each class of the at least one object, comprising:
obtaining a pixel region corresponding to each object in the correction thermal image; and
correcting a temperature corresponding to each pixel region based on the pixel region and the corresponding emissivity, to obtain the target thermal image.

13. The non-transitory storage medium of claim 9, generating the second frequency domain image based on the reference image, comprising:
performing an image enhancing process on the target reference image to generate a target reference image; and
performing a Fourier transform and a high pass filter on the target reference image, to generate the second frequency domain image.

14. The non-transitory storage medium of claim 9, wherein generating the fused thermal image based on the first frequency domain image and the second frequency domain image, comprising:
overlapping the first frequency domain image and the second frequency domain image, to generate a third frequency domain image; and
performing an inverse Fourier transform, to generate the fused thermal image.

15. An electronic device, comprising:
at least one controller; and
a storage device storing a computer program, which when executed by the at least one processor, cause the at least one processor to:
generate a reference image by overlapping the plurality of phase images;
generate a depth image based on the plurality of phase images;
generate a target thermal image based on the original thermal image, the reference image, and the depth image;
generate a first frequency domain image based on the target thermal image;
generate a second frequency domain image based on the reference image; and
generate a fused thermal image based on the first frequency domain image and the second frequency domain image.

16. The electronic device of claim 15, wherein the at least one controller is further caused to:
generate a correction thermal image by using the depth image to correct the original thermal image;
confirm at least one object in the target scene and a class of each of the at least one object based on the reference image;
confirm an emissivity corresponding to each class of the at least one object; and
generate the target thermal image based on the correction thermal image and the emissivity corresponding to each class of the at least one object.

17. The electronic device of claim 16, wherein the at least one controller is further caused to:
acquire a gray value of each pixel point in the depth image; and
correct a temperature of the pixel point in the original thermal image by the gray value, to obtain the correction thermal image.

18. The electronic device of claim 16, wherein the at least one controller is further caused to:
obtain a pixel region corresponding to each object in the correction thermal image; and
correct a temperature corresponding to each pixel region based on the pixel region and the corresponding emissivity, to obtain the target thermal image.

19. The electronic device of claim 15, wherein the at least one controller is further caused to:
perform an image enhancing process on the target reference image to generate a target reference image; and
perform a Fourier transform and a high pass filter on the target reference image, to generate the second frequency domain image.

20. The electronic device of claim 15, wherein the at least one controller is further caused to:
overlap the first frequency domain image and the second frequency domain image, to generate a third frequency domain image; and
perform an inverse Fourier transform, to generate the fused thermal image.
